(19) United States
(12) Patent Application Publication
(10) Pub. No.: US 2004/0252324 A1
(43) Pub. Date: Dec. 16, 2004

(54) Image forming system, computer, computer program product, computer readable storage medium, management method, inspection method and system

(76) Inventor: Yasutoshi Ohta, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/858,203

(22) Filed: Jun. 2, 2004

(30) Foreign Application Priority Data
Jun. 2, 2003 (JP) 2003-157195
Apr. 27, 2004 (JP) 2004-131916

(51) Int. Cl. G06F 3/12; G06F 11/30; G06F 13/00

(52) U.S. Cl. 358/1.14; 399/9; 358/406; 358/1.15; 710/19

(57) ABSTRACT

An image forming system applicable for usage for predicting the failure of an apparatus and making a diagnosis on an apparatus. The image forming system includes an image forming apparatus configured to form an image on a recording medium and a computer configured to manage the image forming apparatus. The image forming apparatus is configured to send internal information to the computer, and the computer is configured to send an inspection program depending on the determination based on the received internal information.

### BACKGROUND OF THE INVENTION

1. Field of the Invention

The present invention relates to an image forming system, a computer, a computer program product, a computer-readable storage medium, an image forming apparatus, a management method, an inspection method, and a system, and specifically that are applicable for usage for predicting the failure of an apparatus and making a diagnosis on an apparatus. The apparatus can include an image forming apparatus.

2. Description of the Background Art

Recently, effective management of an office apparatus including an image forming apparatus through a network is being promoted, to reduce the cost of management of the office apparatus. A network management system for an image forming apparatus has been provided that can not only record a number of discharged sheets and detect a residual quantity of sheets and toner, but that also automatically reports a failure of the image forming apparatus. The failure can be reported to a management center that is established out of the office from where the image forming apparatus is placed.

The automatic reporting system of the failure as noted above includes a system that can report not only the fact of the failure, but also circumstances of the occurrence of the failure or the cause of the failure that is self-diagnosed. Examples of such automatic reporting systems are described below.

In Japanese Patent Laid-Open No. Hei 5-164800 Official Gazette, a diagnosis method and apparatus is disclosed in which failure occurrence information of a multi-function printer (hereinafter referred to as an MFP, on occasion) and information internal to the MFP when the failure occurs is sent from the MFP to a server. The server analyzes the information that is put together in the server statistically and identifies the cause of the failure that is likely to correspond to the information.

In Japanese Patent Laid-Open No. Hei 11-65874 Official Gazette, a server is disclosed for diagnosing a failure to which information that is detected in a MFP is sent. The server identifies the cause of the failure, making use of its superior calculating ability, according to the information. A MFP is also disclosed that identifies the cause of the failure, based on self-diagnosing according to information detected internal to the MFP.

In Japanese Patent Laid-Open No. Hei 11-69063 Official Gazette, an image forming apparatus is disclosed in which a facsimile device can be diagnosed via a personal computer that is externally coupled to the image forming apparatus.

In Japanese Patent Laid-Open No. 2001-69063 Official Gazette, an image forming apparatus is disclosed that analyzes the information detected by a sensor and counter that is placed inside of the image forming apparatus, and that identifies the cause of the failure.

The present inventors recognized there are problems in the above mentioned background arts. Specifically, the computational load to identify the cause of the failure is distributed to either a server or an office apparatus on the network disproportionately. In addition, the server and the office apparatus have to handle many kinds of jobs, because a lot of and various kinds of devices are connected to the network. Accordingly, an unbalanced load distribution is likely to occur, such as one of the server or the office apparatus being overloaded while the resources of the other are not fully utilized. In addition there is a problem that the technology of automatic failure diagnosis is not completely reliable.

### SUMMARY OF THE INVENTION

Accordingly, a general object of the present invention is to provide a novel image forming system, computer, and management method in which a load can be distributed to an image forming apparatus and a computer appropriately.

Another general object of the present invention is to provide a novel computer program product and computer-readable storage medium configured to be executed on the computer to control a load to be distributed to an image forming apparatus and a computer appropriately.

Another general object of the present invention is to provide a novel image forming apparatus and image forming method in which storage space can be saved.

Another general object of the present invention is to provide a novel management method in which a load can be distributed to an apparatus on a network appropriately.

Another general object of the present invention is to provide a novel system in which a load can be distributed to an apparatus and a computer appropriately.

To achieve at least one of the above mentioned objects, there is provided according to an aspect of the present invention an image forming system including an image forming apparatus configured to form an image on a recording medium, and a computer configured to manage the image forming apparatus. The image forming apparatus is configured to send internal information to the computer. The computer is configured to send an inspection program depending on a determination based on the received internal information.

There is also provided according to another aspect of the present invention an image forming system including a mechanism for forming an image on a recording medium, and a mechanism for managing the image forming mechanism. The image forming mechanism includes a mechanism for sending internal information to the managing mechanism. The managing mechanism includes a mechanism for sending an inspection program depending on a determination based on the internal information.

According to the above mentioned image forming systems, a load can be distributed to an image forming apparatus and a computer appropriately.

To achieve at least one of the above mentioned objects, there is provided according to another aspect of the present invention a computer for use with an image forming apparatus. The image forming apparatus is configured to form an image on a recording medium and to send internal information to the computer. The computer is configured to send an inspection program depending on a determination based on the internal information.

There is also provided according to another aspect of the present invention a computer for use with an image forming apparatus. The image forming apparatus includes a mechanism for forming an image on a recording medium, and a mechanism for sending internal information to the computer. The computer includes a mechanism for sending an inspection program depending on a determination based on the internal information.

According to the above mentioned computers, a load can be distributed to an image forming apparatus and a computer appropriately.

To achieve at least one of the above mentioned objects, there is provided according to another aspect of the present invention a computer program product for a computer for use with an image forming apparatus. The image forming apparatus is configured to form an image on a recording medium and send internal information to the computer. The computer program product enables the computer to execute a process. The process includes sending an inspection program to the image forming device depending on a determination based on the internal information.

To achieve at least one of the above mentioned objects, there is provided according to another aspect of the present invention a computer-readable storage medium storing the above mentioned computer program product.

According to the above mentioned computer program product and computer-readable storage medium, the computer operates such that a load can be distributed to an image forming apparatus and a computer appropriately.

To achieve at least one of the above mentioned objects, there is provided according to another aspect of the present invention an image forming apparatus for forming an image on a recording medium. The image forming apparatus is configured to execute an inspection program sent from a network and to output an inspection result obtained by the execution of the inspection program.

There is also provided according to another aspect of the present invention an image forming apparatus for forming an image on a recording medium. The image forming apparatus includes a mechanism for executing an inspection program sent through a network and a mechanism for outputting an inspection result obtained by execution of the inspection program.

According to the above mentioned image forming apparatus, storage space of the image forming apparatus can be saved, because the image forming apparatus need not always store the inspection program.

To achieve at least one of the above mentioned objects, there is provided according to another aspect of the present invention a management method for managing an image forming apparatus. The image forming apparatus is configured to form an image on a recording medium, and to output internal information. The management method includes receiving internal information and sending an inspection program depending on a determination based on the internal information.

According to the above mentioned management method, an appropriate load can be distributed to the image forming apparatus.

To achieve at least one of the above mentioned objects, there is provided according to another aspect of the present invention an inspection method. The inspection method forms an image on a recording medium, executes an inspection program sent through a network for inspecting the forming, and sends an inspection result obtained by the execution of the inspection program.

According to the above mentioned inspection method, storage space can be saved, because the inspection program need not always be stored.

To achieve at least one of the above mentioned objects, there is provided according to another aspect of the present invention a management method. The management method sends internal information to a network, receives the internal information from the network, and sends an inspection program depending on a determination based on the internal information, to the network.

According to the above mentioned management method, an appropriate load can be distributed to an apparatus on the network.

To achieve at least one of the above mentioned objects, there is provided according to another aspect of the present invention a system. The system has an apparatus and a computer configured to manage the apparatus. The apparatus is configured to send internal information to the computer. The computer is configured to send an inspection program depending on a determination based on the internal information, to the apparatus.

According to the above mentioned image forming systems, a load can be distributed to the image forming apparatus and the computer appropriately.

Other objects and further features of the present invention will be apparent from the following detailed description when read in conjunction with the accompanying drawings.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of system architecture in a preferred embodiment, according to the present invention;

FIG. 2 indicates a diagram of a process of failure prediction in a preferred embodiment, according to the present invention;

FIG. 3 is a block diagram of a multi-function printer of a preferred embodiment, according to the present invention;

FIG. 4 is a block diagram of a management server in a preferred embodiment, according to the present invention;

FIG. 5 is a flow chart of an operation of programs in a preferred embodiment, according to the present invention;

FIG. 6 is a block diagram of a multi-function printer of a print engine unit, a sheet supplying unit, and a sheet discharging unit in a preferred embodiment, according to the present invention;

FIGS. 7A to 7C are diagrams illustrating operation of a management server executing a management program in a preferred embodiment, according to the present invention; and

FIG. 8 is a flow chart describing an operation of a management server executing a management program in a preferred embodiment, according to the present invention.

### DETAILED DESCRIPTION OF THE PREFERRED EMBODIMENTS

The preferred embodiments of an image forming system, an image forming method, a computer program product, and a computer-readable storage medium according to the present invention will be precisely described in accordance with the accompanying drawings below, in which like reference numerals indicate identical or corresponding elements throughout the several views.

In the first instance, an example of system architecture in a preferred embodiment is described.

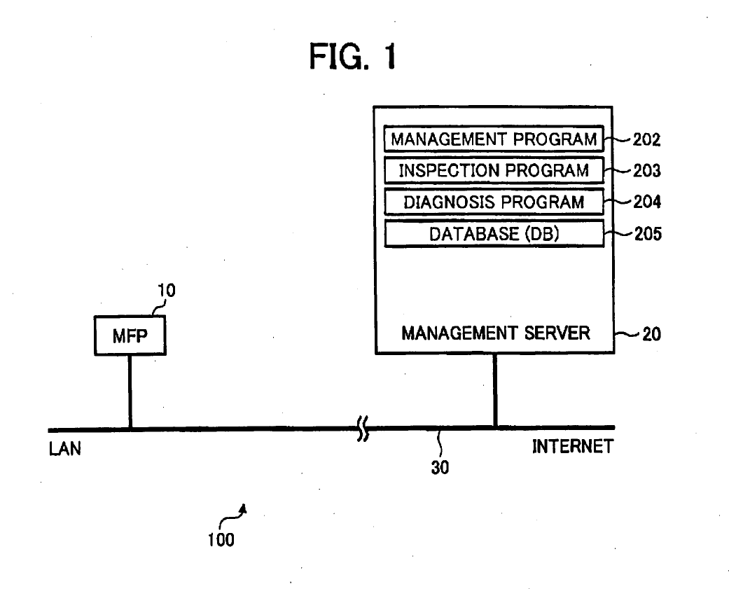

FIG. 1 is a block diagram of system architecture according to a preferred embodiment.

In FIG. 1 an image forming system 100 indicates a MFP 10 that has a plurality of functions, such as a printer, a copier, a scanner, a facsimile, a management server 20, and a network 30. In this example, the MFP 10 serves as an image forming apparatus. The MFP 10 and the management server 20 are connected to each other by the network 30. As well-known a computer can serve as the management server 20. In addition, the network 30 includes wired and wireless networks.

The MFP 10 is connected to a local area network (LAN), as the network 30 in this example, that is managed by a user, and the management server 20 can be a WEB server managed by the manufacturer of the MFP 10. That is to say, the MFP 10 and the management server 20 can be connected to each other over the Internet. Though only one MFP 10 is shown in FIG. 1, the management server 20 can communicate with plural MFPs connected to the Internet.

The MFP 10 and the management server communicate information via, e.g., a gateway and a firewall. A management program 202, an inspection program 203, and a diagnosis program 204 can be stored in the management server 20. The management program 202 is configured to manage the MFP 10. The inspection program 203 is configured to inspect the MFP 10 and is started when needed. The diagnosis program 204 is configured to diagnose the MFP 10 based on the inspection result of the inspection program 22.

The process of failure prediction of the MFP 10 in this embodiment is now described.

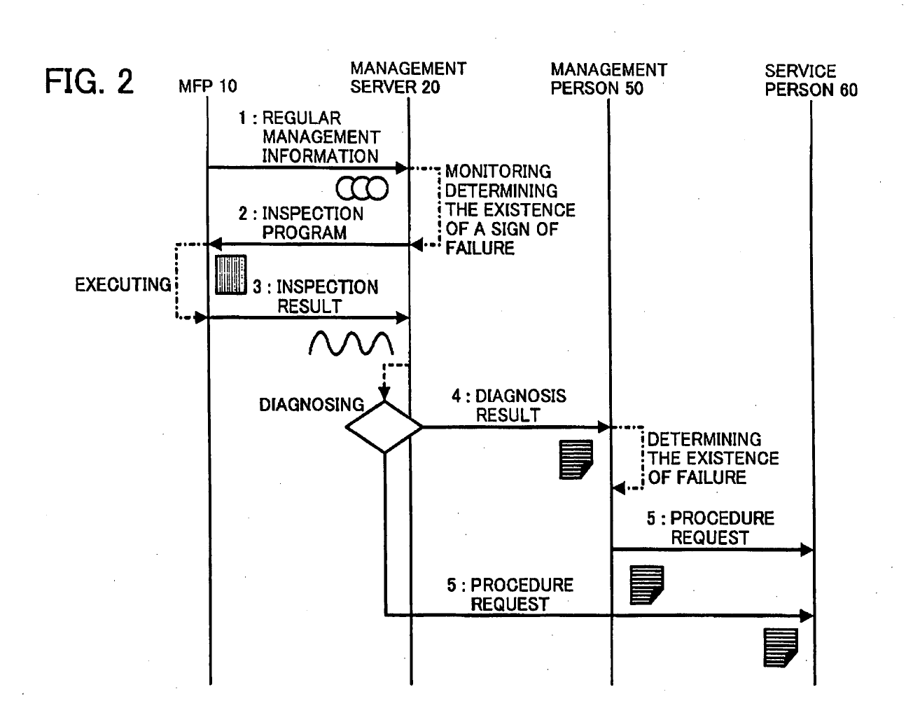

One feature of this embodiment exists in that the system 100 can predict the failure of the MFP 10 efficiently, because of cooperation between the MFP 10, the management server 20, and a management person. The precise process is described according to FIG. 2.

FIG. 2 indicates a diagram of the process of the failure prediction in this embodiment.

In normal circumstances, the MFP 10 sends internal regular management information of the MFP 10 to the management server 20 at regular intervals (operation 1).

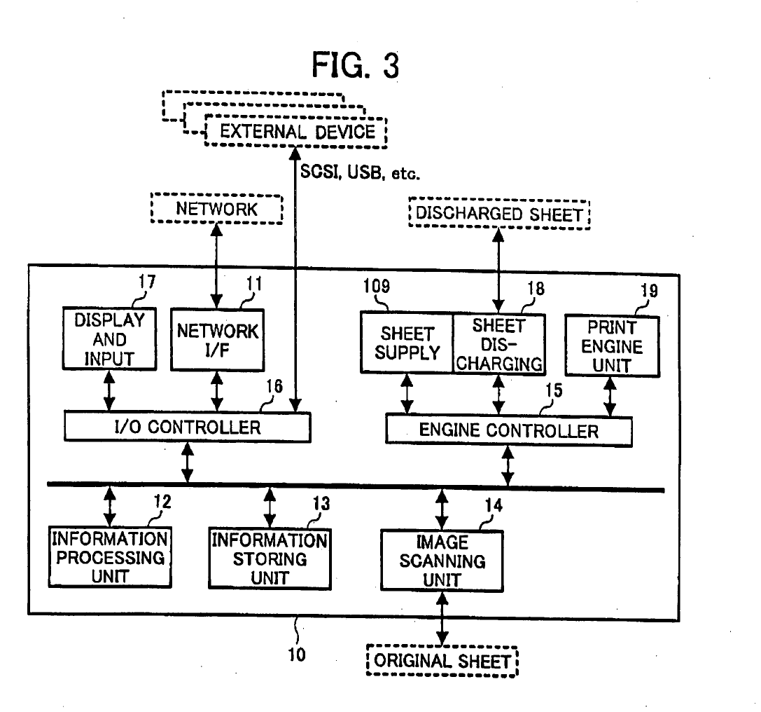

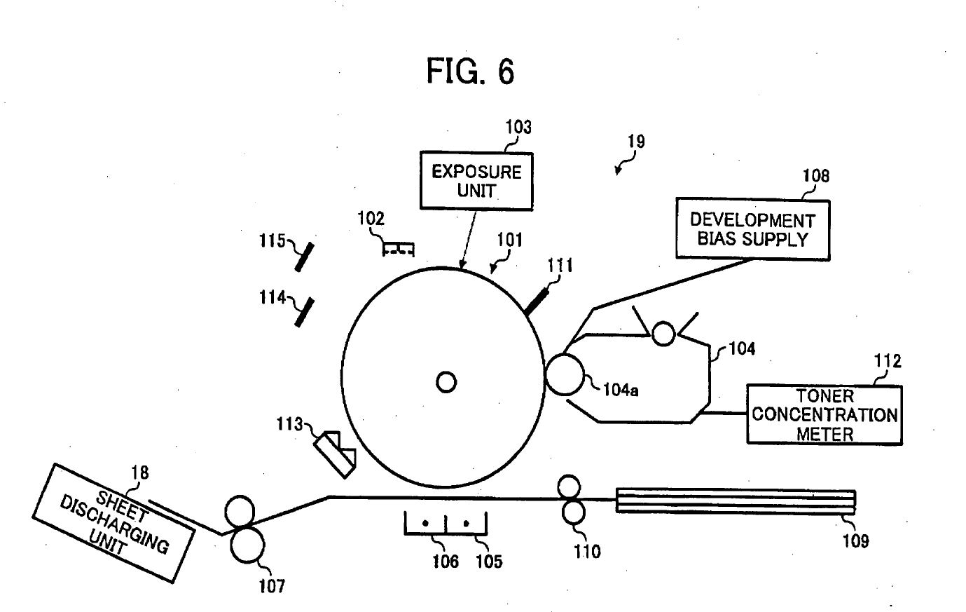

In this embodiment, static information (as the internal information) includes sensor information from various sensors in the MFP 10, an identification number (a serial number) of the MFP 10, and a counter value, which are sent from the MFP 10 to the management server 20 at regular intervals (this is referred to as regular management information in FIG. 2). The sensor information is information detected by sensors placed in the MFP 10 and can include information of temperature, humidity, voltage, etc. The counter value is a value counted by a counter that is placed in MFP 10 and includes a number of discharged sheets. The arrangement of sensors in the MFP 10 can be as described in FIG. 6. The serial number of the MFP 10 is stored in an information storing unit 13 and the counter value is written into the information storing unit 13 by an information processing unit 12, as shown in FIG. 3.

FIG. 6 is a block diagram of a print engine unit (image forming device) 19, a sheet supplying unit 109, and a sheet discharging unit 18 of the MFP 10 in this embodiment. A photoconductor drum 101 of the MFP 10 includes an organic photoconductor. The print engine unit 19 includes a charge unit 102, an exposure unit 103, a development unit 104, a transfer unit 105, a separation unit 106, and a fixing unit 107 that are arranged around the photoconductor drum 101 sequentially.

The photoconductor drum 101 is rotated by a motor, and is uniformly charged by the charge unit 102. Then, the surface of the photoconductor drum 101 is exposed by a laser beam that is emitted from the exposure unit 103 based on an original image. A latent image is formed on the surface of the photoconductor drum 101 according to the exposure operation. The latent image on the surface of the photoconductor drum 101 is then developed with toner to form a visible toner image by a development roller 104a of the development unit 104. A development bias supply 108 applies constant development bias to the development roller 104a. Then, the visible toner image is transferred onto a paper sheet, which is fed from the sheet supplying unit 109 through a registration roller pair 110, by the transfer unit 105.

The separation unit 106 separates the paper sheet onto which the visible image is transferred from the photoconductor drum 101. Then, the paper sheet is conveyed to the fixing unit 107, and the fixing unit 107 fixes the visible image onto the paper sheet. The paper sheet onto which the visible image is formed is discharged onto the sheet discharging unit 18. In addition, residual toner remaining on the photoconductor drum 101 is removed from the surface of the photoconductor drum 105 by a cleaning unit (not shown).

The MFP 10 has various sensors (detecting units) including a photoconductor surface electrometer 111, a toner concentration meter 112, an image thickness sensor 113, a temperature sensor 114, and a humidity sensor 115.

The photoconductor surface electrometer 111 detects electric potential of the surface of the photoconductor drum 101, that is the electric potential of the portion of the photoconductor drum 101 charged by charging unit 102 and the portion exposed by the exposure unit 103. The toner concentration meter 112 detects the density of toner in the development unit 104. The image thickness sensor 113 detects the thickness of the visible image on the photoconductor drum 101. The temperature sensor 114 and the humidity sensor 115 detect the temperature and the humidity around the photoconductor drum 101 respectively.

The management server 20 executing the management program 202 stores the internal information from the MFP 10 into a database 205 (hereinafter referred to as DB) and monitors the contents of the DB 205 at regular intervals. When the management server 20 determines that there is sign of failure in the MFP 10, as a result of the monitoring, the management server 20 sends the inspection program 203 to the MFP 10 to obtain precise information of the failure from the MFP 10 (operation 2 in FIG. 2).

More concretely, each internal information sent from the MFP 10 has vectors of n dimension when the internal information is stored in the DB 205. For example, when each internal information includes temperature, humidity, counter value, and identification number, the internal information has vectors of 4 dimension. The management server 20 executing the management program 202 determines the vectors of n dimension as normal or abnormal based on supervised parameters, which is prepared in the DB 205 in advance. When the vectors are determined to be abnormal, that is determined as a sign of a failure. As an example of a simple algorithm of the management program 202, there is an algorithm that determines the vectors as normal or abnormal based on degree of similarity to predetermined supervised parameters. A neural network (hereinafter referred to as a NN) that has been trained with the use of the supervised parameters and a support vector machine (hereinafter referred to as a SVM) that is a kind of kernel machine can also be used for the algorithm of the management program 202.

A SVM is suitable for making binary determination from input data, and burdens computers less than a NN. Moreover a SVM has a high level performance when the SVM makes a determination as to untrained data. That is because a SVM can generate a nonlinear function for determination with the technique “kernel trick” that the determination is made linearly in a space obtained by converting a feature vector. Accordingly a SVM is one of the most superior training models among many presently known models. A more precise explanation about a SVM is disclosed in http://www.neurosci.aist.gojp/˜kurita/lecture/svm.pdf (“Introduction of support vector machine”, Takio Kurita Neuroscience Research Institute, National Institute of Advanced Industrial Science and Technology), for example.

In this embodiment, a SVM is used as the algorithm of the management program 21, because the SVM can determine normal or abnormal conditions accurately when expressing vectors of n dimension spatially. The precise method of the determination by SVM is noted below.

In this embodiment, the inspection program 203 is stored in the management server 20, and is not stored in the MFP 10 when the MFP is 10 manufactured. Accordingly, an updated inspection program can always be provided (in operation 2 in FIG. 2), and the storage space of the MFP 10 can be saved.

The management server 20 obtains precise information depending on the determination including of the management program 202 and, when needed, of a management person. Accordingly, the management server need not obtain precise information from all of the MFPs connected to the network 30, and thereby the storage quantity of the DB 205 and the load of the network 30 can be reduced.

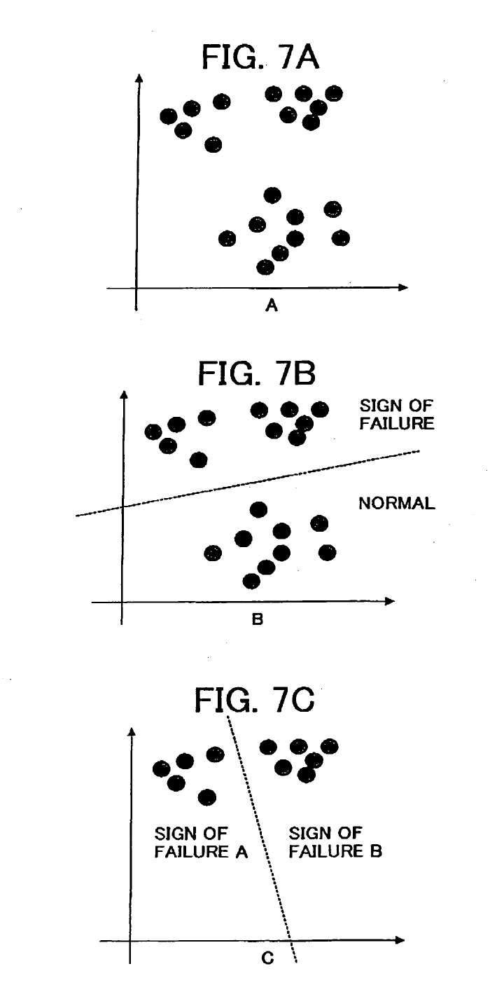

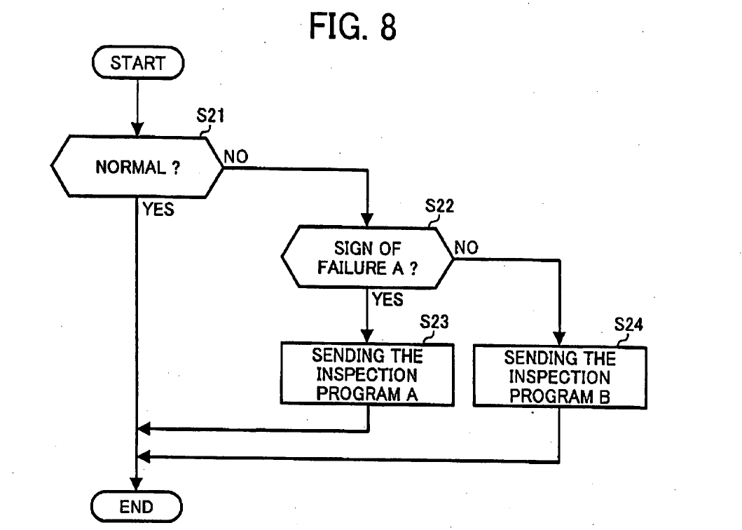

A plurality of inspection programs 203 can be stored in the management server 20, and the management server 20 executing the management program 202 can select one of the inspection programs 203 and send the selected inspection program to the MFP 10 (see operation 2 in FIG. 2). The MFP 10 executes the inspection program 203 according to a predetermined process. Then, the MFP 10 sends an inspection result obtained by the execution of the inspection program 2, to the management server 20 (operation 3 in FIG. 2). FIGS. 7A to 7C are diagrams illustrating the operation of the management server 20 executing the management program 202 in this embodiment. FIG. 8 is a flow chart describing the operation of the management server 20 executing the management program 202 in this embodiment. For convenience of the explanation, the internal information monitored by the execution of the management program 202 is assumed to have vectors of 2 dimension. FIG. 7A indicates the distribution of the data included in the internal information sent from the MFP 10. Then, in step S21 in FIG. 8, the management server 20 discriminates between normal data and abnormal data (which is thought to be a sign of failure), as is shown in FIG. 7B. In addition, the broken line in FIG. 7B indicates the boundary between normal data and abnormal data, which is determined by a SVM. In step S22 in FIG. 8, after abnormal data is deleted in step S21, the management server 20 determines what kind of sign of failure the abnormal data corresponds to with the use of the abnormal data, as is shown in FIG. 7C. In addition, the broken line in FIG. 7C indicates the boundary between a sign of failure A and a sign of failure B, which is determined by a SVM. When it is determined that there is the sign of failure A in step S22 of FIG. 8 (Yes in step S22), the management server 20 sends the inspection program A in step S23 of FIG. 8. When it is determined that there is the sign of failure B in step S22 of FIG. 8 (No in step S22), the management server 20 sends the inspection program B in step S24 of FIG. 8. As explained above, the management server 20 discriminates among normal, sign of failure A, sign of failure B, using two SVMs.

The management server 20 selects and sends one inspection program depending on the kind of sign of failure in this embodiment. But the image forming system 100 can be designed such that the management server 20 sends all inspection programs to the MFP 10 after determining the internal information includes abnormal data, and the MFP 10 can execute each inspection program sequentially, when the number of the inspection program is relatively small and the execution of the inspection programs does not excessively burden the MFP 10 and the network 30.

Generally speaking, there are active types and passive types of inspection programs. The active types of inspection programs are generally used when the cause or causal connection of the failure is apparent. In this case, the MFP 10 executing an active type of inspection program controls components of the MFP 10 in a predetermined manner and obtains information detected by a sensor. Examples of the execution are as follows: turning on the motor of the photoconductor drum 101, obtaining information from the image thickness sensor 113, turning off the motor of the photoconductor drum 101, turning on the motor of the development roller 104a, obtaining information from the toner concentration meter 112, and turning off the motor of the development roller 104a. The execution process of the active type of inspection program is referred to as a test sequence.

The passive types of inspection programs are generally used when it is unpredictable when the phenomenon that should be observed occurs or when the cause of the sign of failure is not apparent. The MFP 10 does not control its components by the execution of the passive type of inspection program. The MFP 10 keeps on executing the passive type of inspection program and monitoring the information detected by sensors, by the execution of the inspection program. When information satisfying a predetermined condition is detected, the MFP 10 sends the information detected to the management server 20. The predetermined condition can be such as “the temperature detected by the temperature sensor 114 becomes over 40° C.,” and “the identification number of the MFP 10 is from 15000 to 18000”, for example.

As noted above, the inspection program 203 operates as a type of program that controls the internal operation of the MFP 10. Thus, it is preferable that the inspection program 203 is executed by the MFP 10 after the MFP 10 has downloaded the inspection program 203, or is designed as a migration agent program.

As to a migration agent program, a precise explanation is disclosed in Japanese Patent Laid-Open No. Hei 7-182174 Official Gazette, for example. A migration agent program is a program that can migrate a node to another node through the network 30 and can be executed autonomously in the node after migration. In other words, the migration program is a program that can migrate in the network and be executed in a remote node as an agent of a device in which the operation is needed. When the inspection program 22 is a migration program, the MFP 10 executes the inspection program 22 using a remote device as an agent of the MFP 10. When a migration agent program is used as the inspection program 22, the storage space of the MFP 10 can be even further saved.

In addition, though it is illustrated that the process of sending the inspection program 203 and the inspection result is executed once in FIG. 2, the process can be executed repeatedly when needed.

The inspection program 203 is stored in a RAM of the MFP 10 temporally and the MFP 10 does not save the inspection program 203 after the execution of the inspection program 203. In this case, the inspection program 203 self-destructs after the MFP 10 is turned off. However, a passive type of inspection program is kept in the MFP 10 to monitor unpredictable phenomenon, and is thereby incorporated in the stationary operation of the MFP 10. In this case, it is possible that the term for inspection becomes long, so the MFP 10 can save the passive type of inspection program in a nonvolatile memory such as a flash memory. The passive type of inspection program does not destruct after the MFP 10 is turned off and restarts when the MFP 10 is turned on again.

It is possible that a data amount of the inspection result becomes large after the inspection, because the inspection result may include information detected by many sensors at regular intervals over a long period of time, depending on the inspection program. Such a large amount of data of the inspection result may burden the MFP 10 and the network 30 excessively. Accordingly, it is preferable that the inspection program is designed to be executed during an idling time of the MFP 10, for example in the early-morning and late evening.

The inspection result can be sent to the management server 20 (operation 3 in FIG. 2) as quantized data after A/D conversion in the MFP 10. The inspection result can be also sent to the management server 20 as converted data or compressed data.

The management server 20 executing the diagnosis program can output a failure certainty value in the range from 0 to 100 corresponding to the input data of the inspection result and the history thereof. Then, the failure certainty value can be divided into three classifications by two predetermined thresholds that are set in advance. For example, two thresholds can be set to 20 and 85 respectively. In this case, the management server 20 sends a procedure request (operation 5 in FIG. 2) to a service person 60 if the failure certainty value equals 95. The management server 20 sends a diagnosis result (operation 4 in FIG. 2) to a management person 50 and requests the management person 50 to determine whether a failure exists, if the failure certainty value equals 50. The management server 20 determines that there exists no failure (no procedure is needed), if the failure certainty value equals 15. As explained above, the management server 20 executing the diagnosis program selects one of three procedures in this embodiment. The value and number of thresholds, and the range of failure certainty value, can be set differently as noted above as thought proper for the particulars of the image forming system 100.

The diagnosis program can be an expert system in which an analysis rule is described, or a Bayesian Network. A method with quality engineering including a Mahalanobis-Taguchi System can also apply to the diagnosis program. The Bayesian Network is a system in which the cause of the failure is probabilisticly deducted based on inputs including information detected by sensors. The Bayesian Network is different from a NN in that designers or users themselves define the network, which corresponds to a middle layer of a NN.

When the existence and cause of the failure becomes apparent for the management system 20 executing the diagnosis program, the management system 20 sends the procedure request (operation 5 in FIG. 2) including a request for component replacement to the service person 60 directly, not going through the management person 50. To the contrary, when it becomes apparent to the management system 20 that a failure does not exist, the management system 20 determines that there is no need for procedure and goes back to a stationary monitoring operation.

The management system 20 leaves the determination about the existence and cause of failure to the management person 50, when the existence and cause of the failure is uncertain to the management system 20. The management person 50 who receives the diagnosis result (operation 4 in FIG. 2) from the management system 20 determines the existence and cause of failure based on the diagnosis result. Then, the management person 50 sends the procedure request (operation 5′ in FIG. 2) to the service person 60, or determines that there is no need for any further procedures. When the management person 50 determines that there is no need for any further procedures, the management server 20 goes back to a stationary monitoring operation.

In this embodiment, the management person 50 need not check every inspection result, because the management server 20 can screen the inspection results in advance. Accordingly, labor savings for management of the system 100 becomes possible, and the image forming system 100 can be managed efficiently by a selected professional engineer as the management person 50.

Moreover, the management person 50 can make an accurate determination in a short time, because the materials to make the determination, including longitudinal information and information in executing the test sequence, have been already prepared when the management person 50 makes the determination.

The diagnosis program 204 need not to be able to determine the existence and cause of failure completely because the management system 20 can leave the determination to the management person 50, when the existence and cause of the failure is uncertain to the management system 20. Accordingly, the diagnosis program 23 is designed easily.

The service person 60 can often deal with the failure more efficiently; for example it increases the possibility that the service person 60 take action including the alignment and replacement of a component of the MFP 10 in a short time and by a small number of times. That is because the service person 60 receives the procedure request after the diagnosis of the management server 20.

In addition, the diagnosis program 204 can be designed to send a procedure request that is classified in terms of the urgency (for example the procedure is needed in 24 hours, 3 days, or 1 week). In this case, the service person 60 can schedule his/her jobs more efficiently.

If the service person 60 is not supposed to perform the maintenance of the MFP 10, the image forming system 100 can be designed to order components automatically corresponding to the determination of the management person 50.

The construction of the MFP 10 in this embodiment is now described in further detail. FIG. 3 is a block diagram of the MFP 10 in this embodiment.

In FIG. 3, the MFP 10 has a network interface (I/F) 11, an information processing unit 12, an information storing unit 13, an image scanning unit 14, an engine controller 15, I/O controller 16, a display and input unit 17, the print engine unit 19, the sheet supplying unit 109, and the sheet discharging unit 18.

The network interface 11 deals with communication through the network 30. A network interface card (NIC) can be used as the network interface 11. The information processing unit 12 deals with processing various information including information detected by sensors, executing the inspection program 203, sending the internal information and the inspection result with the network interface 11, and controlling the operations of the MFP 10. A CPU can be used as the information processing unit 12. Storage devices including a RAM, a ROM, a hard disk drive and a combination thereof can be used for the information storing unit 13. The ROM stores various control programs such as for a system operation and operations of copy, facsimile, printing, page description language processing system for printing, default values of the system, for example. The RAM is normally used as a working memory.

The image scanning unit 14 normally includes a scanner to read images from original sheets and an auto document feeder (ADF). The engine controller 15 controls the operation of the print engine unit 19 including the photoconductor drum 101 and the cleaning unit (not shown), the sheet supplying unit 109, and the sheet discharging unit 18 in the MFP 10. I/O controller 16 includes a SCSI, USB controller and controls the operation of input and output between external devices and the MFP 10. A touch panel or a display with buttons or switches, for users to control the MFP 10, can be used as the display and input unit 17. The print engine unit 19, the sheet supplying unit 109, and the sheet discharging unit 18 are as is described in FIG. 6.

In addition, frames with broken lines indicate devices that are placed out of the MFP 10. When the MFP 10 has the function of a facsimile, the MFP 10 has a line control unit including a modular jack and network control unit (NCU).

In the MFP 10, various sensors are included as described above with reference to FIG. 6. In addition, an acceleration sensor to detect vibrations in the MFP 10 can be placed in the MFP 10. The information processing unit can access those sensors, such that the information from those sensors can be utilized by the management program 21 and the inspection program 203. The price of those sensors is different depending on their accuracy. For example, the price between a semiconductor type acceleration sensor to conduct two-axle detection and a gyro type acceleration sensor to conduct three-axle detection, which is more accurate, is different. So the number and types of sensors can be decided in terms of accuracy and cost performance of the MFP 10, and the desired diagnosis ability of the image forming system 100, in designing the image forming system 100.

Generally, voltage, temperature, humidity, and angular speed of the body of rotation are detected in the MFP 10. In addition, a microphone and an acceleration sensor are preferably used because their cost performance is high.

To detect the change of the thickness of images, an image thickness sensors after transferring and fixing can be provided in addition to the above mentioned image thickness sensor 113.

The construction of the management server 20 in this embodiment is now described.

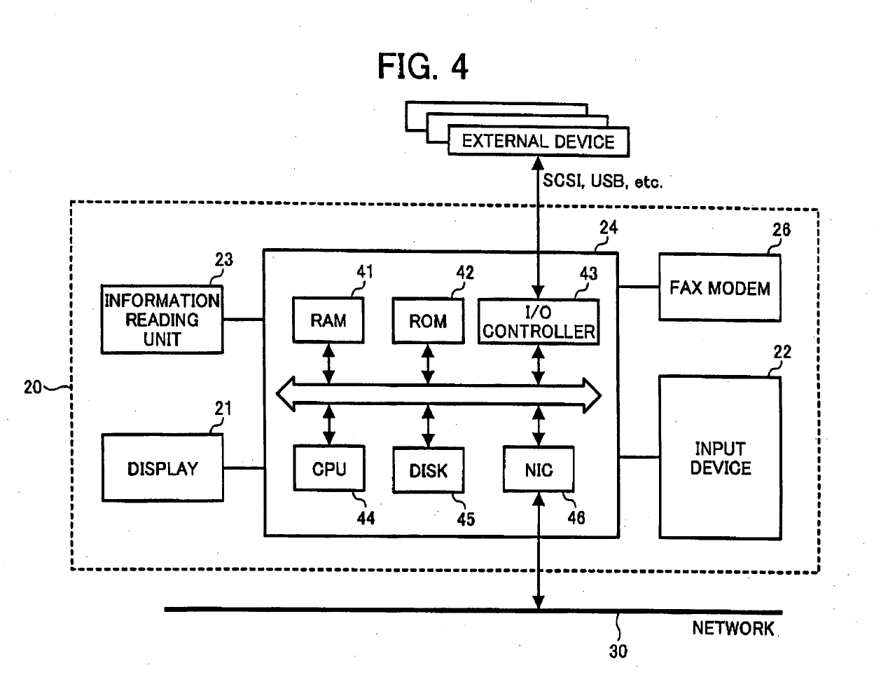

FIG. 4 is a block diagram of the management server 20 in this embodiment. A well-known computer can be used as the management server 20. The management server 20 includes a display 21, an input device 22, an information reading unit 23 to read out information from a storage medium including a floppy disk drive (FDD), a calculation unit 24, and a facsimile modem 26.

The calculation unit 24 includes a CPU 44, an information storing unit having a RAM 41 and ROM 42, a DISK (a high-capacity storage device) 45 built in the management server 20, a network interface card (NIC) 46 to deal with communication through the network 30, and an I/O controller 43 to communicate with external devices. The I/O controller 43 includes an USB port and a SCSI port

The DISK 45 stores the management program 202, the inspection program(s) 203, and the diagnosis program 204, and information included in the DB 205. Other storage devices including a HDD and a flash memory can be used as the information storing unit of the management server 20, in addition to the RAM 41 and ROM 42.

The management server 20 keeps on executing the management program 202. The inspection program 203 and the diagnosis program 204 are activated according to an order from the management program 202, when needed.

It is preferable that the DB 205 is independent from programs. That is because the data amount of the inspection result including the information sensed at regular intervals over a long period of time collected through the network 30 from MFP 10 can become large, and it is preferable that the information in the DB 205 is commonly accessible by each of the programs.

In addition, though the DB 205 and the programs are stored in the management server 20 in this embodiment, a server for storing the DB 205 that is independent from the management server 20 can be utilized.

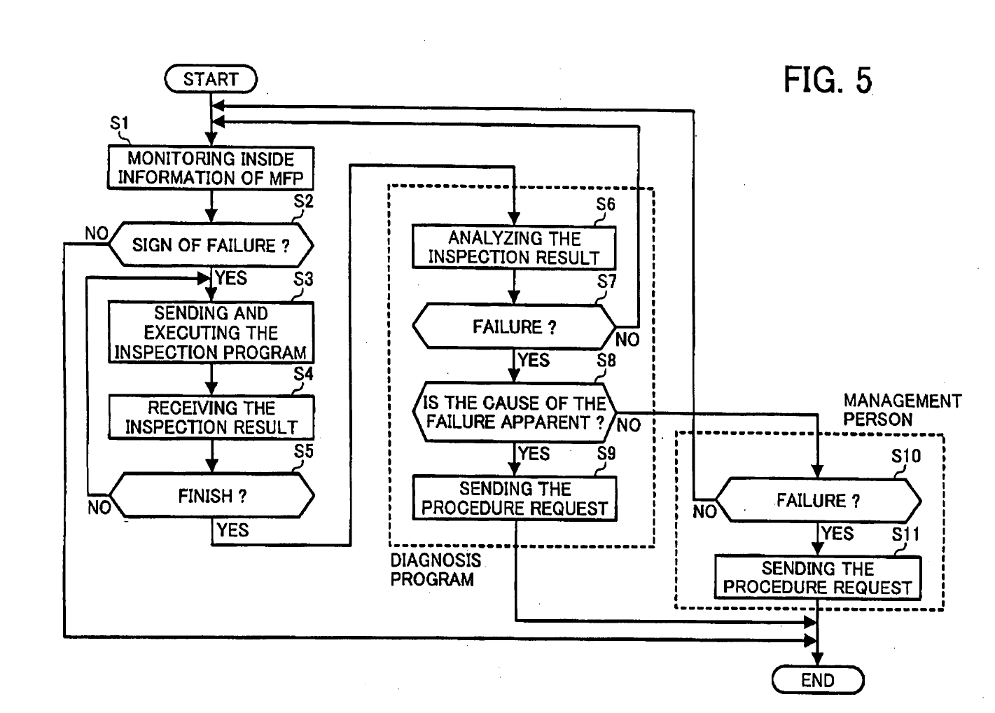

The algorithm of the programs in this embodiment is now described with reference to FIG. 5.

One feature of this embodiment exists in that the failure of the MFP 10 can be predicted efficiently with the programs, because of the cooperation of the MFP 10, the management server 20, and a management person.

FIG. 5 is a flow chart of the operation of the programs in this embodiment.

In step S1, the management server 20 monitors internal information of the MFP 10 sent from the MFP 10 in normal circumstances at regular intervals.

In step S2, the management server 20 determines whether there is sign of failure in the MFP 10, as a result of the monitoring. The sign of failure includes a mismatch of values detected by the sensors from desired normal values. When the failure of a specific component is predicted from the number of discharged sheets and a normal moment-to-moment change of the specific component, the management server 20 determines there is a sign of failure. When the management server 20 determines there is a sign of failure (Yes in step S2), the management server 20 sends the inspection program 203 to the MFP 10 to obtain more precise information, in step S3. The management server 20 monitors the transmission of the inspection result in step S4. The management server 20 determines whether the reception of the inspection result is completed in step S5. When the reception of the inspection result is completed (Yes in step S5), the management server 20 proceeds to the operation of step S6. When the reception of the inspection result is not completed (No in step S5), the management server 20 sends the inspection program 203 to the MFP 10 again in step S3.

There can be a plurality of inspection programs. The management server 20 can then select and send an appropriate inspection program(s). So, step S1 to step S5 can be executed repeatedly.

The inspection result obtained by the inspection program 203 is diagnosed by the management server 20 executing the diagnosis program in step S6 (after Yes in step S5). When the management server 20 determines that the failure exists in step S7 (Yes in step S7), the management server 20 determines whether the cause of the failure is apparent, in step S8. When the management server 20 determines the cause of the failure is apparent (Yes in step S8), the management server 20 sends the procedure request to the service person 60 in step S9. When the management server 20 determines that the failure does not exist (No in step S7), the management server 20 returns to monitoring internal information of the MFP 10 in step S1.

When the management server 20 determines that the cause of the failure is uncertain or unassertive in step S8 (No in step S8), the management server 20 sends the diagnosis information to the management person 50 and leaves the determination to the management person 50. The management person 50 then determines the existence of the failure based on the diagnosis information in step S10. When the management person 50 determines that the failure exists, the management person 50 sends the procedure request to the service person 60 in step S11. When the management person 50 determines that the failure does not exist and there is no need for procedure (No in step S10), the management server 20 returns to monitoring the internal information of the MFP 10 in step S1.

In this embodiment, the management person 50 need not check every inspection result, because the management server 20 screens the inspection results in advance. Accordingly labor saving for the management of the system 100 becomes possible, and the image forming system 100 can be managed efficiently by a selected professional engineer as the management person 50.

According to the present invention, there is provided an image forming system, a computer, and a management method, in which a load can be distributed to an image forming apparatus and a computer appropriately.

According to the present invention, there is also provided a computer program product and a computer-readable storage medium configured to be executed on the computer, such that a load can be distributed to an image forming apparatus and a computer appropriately.

According to the present invention, there is also provided an image forming apparatus and image forming method whose storage space can be saved.

According to the present invention, there is also provided a management method in which a load can be distributed to an apparatus on a network appropriately.

According to the present invention, there is also provided a system in which a load can be distributed to an apparatus and a computer appropriately.

Obviously, numerous modifications and variations of the present invention are possible in light of the above teachings. It is therefore to be understood that within the scope of the appended claims, the present invention may be practiced otherwise than as specifically described herein.

The present application contains subject matter related to Japanese patent application no. JP 2003-157195, filed in the Japanese Patent Office on Jun. 2, 2003, and Japanese patent application no. JP 2004-131916, filed in the Japanese Patent Office on Apr. 27, 2004, the entire contents of each of which are hereby incorporated herein by reference.

What is claimed is:

1. An image forming system comprising:
an image forming apparatus configured to form an image on a recording medium; and
a computer configured to manage said image forming apparatus; wherein:
said image forming apparatus is configured to send internal information to said computer; and
said computer is configured to send an inspection program depending on a determination based on the internal information.

2. An image forming system according to claim 1, wherein:
said internal information includes static information.

3. An image forming system according to claim 2, wherein:
said static information includes at least one of an identification information of said image forming apparatus and a number of recording mediums discharged from said image forming apparatus.

4. An image forming system according to claim 1, wherein:
said image forming apparatus is further configured to execute said inspection program, and to send an inspection result obtained by execution of said inspection program to said computer; and
said computer is further configured to make a diagnosis based on the inspection result.

5. An image forming system according to claim 4, wherein:
said computer is further configured to send a procedure request depending on a result of the diagnosis.

6. An image forming system according to claim 4, wherein:
said computer is further configured to output a diagnosis result depending on a result of the diagnosis.

7. An image forming system according to claim 4, wherein:
said computer is further configured to order a component of said image forming apparatus depending on a result of the diagnosis.

8. An image forming system according to claim 1, wherein:
the inspection program is configured to be storable in said image forming apparatus.

9. An image forming system according to claim 1, wherein:
the inspection program includes a migration agent program.

10. A computer for use with an image forming apparatus that is configured to form an image on a recording medium, and send internal information to the computer, comprising:
a first control configured to send an inspection program to the image forming apparatus depending on a determination based on the internal information.

11. A computer according to claim 10, wherein:
the internal information includes static information.

12. A computer according to claim 11, wherein:
the static information includes at least one of an identification information of the image forming apparatus and a number of recording mediums discharged from the image forming apparatus.

13. A computer according to claim 10, wherein the image forming apparatus is further configured to execute the inspection program, and send an inspection result obtained by execution of the inspection program to the computer, and the computer further comprising:
a second control configured to make a diagnosis based on the inspection result.

14. A computer according to claim 13, further comprising:
a third control configured to output a procedure request depending on a result of the diagnosis.

15. A computer according to claim 13, further comprising:
a third control configured to output a diagnosis result depending on a result of the diagnosis.

16. A computer according to claim 13, further comprising:
a third control configured to order a component of the image forming apparatus depending on a result of the diagnosis.

17. A computer according to claim 10, wherein:
the inspection program is configured to be storable in the image forming apparatus.

18. A computer according to claim 10, wherein:
the inspection program includes a migration agent program.

19. A computer program product for a computer for use with an image forming apparatus that is configured to form an image on a recording medium and send internal information to the computer, to enable the computer to execute a process, wherein the process comprises:
sending an inspection program to the image forming device depending on a determination based on the internal information.

20. A computer program product according to claim 19, wherein:
the internal information includes static information.

21. A computer program product according to claim 20, wherein:
the static information includes at least one of an identification information of the image forming apparatus and a number of recording mediums discharged from the image forming apparatus.

22. A computer program product according to claim 19, wherein the image forming apparatus is configured to execute the inspection program, and send an inspection result obtained by the execution of the inspection program to the computer, the process further comprising:
making a diagnosis of the inspection result.

23. A computer program product according to claim 22, the process further comprising:
outputting a procedure request depending on a result of the diagnosis.

24. A computer program product according to claim 22, the process further comprising:
outputting a diagnosis result depending on a result of the diagnosis.

25. A computer program product according to claim 22, the process further comprising:
ordering a component of the image forming apparatus depending on a result of the diagnosis.

26. A computer program product according to claim 19, wherein:
the inspection program is configured to be storable in the image forming apparatus.

27. A computer program product according to claim 19, wherein:
the inspection program includes a migration agent program.

28. A computer-readable storage medium wherein:
the computer-readable storage medium stores a computer program product according to claim 19.

29. An image forming apparatus for forming an image on a recording medium, comprising:
a first control configured to execute an inspection program sent from a network and to output an inspection result obtained by execution of the inspection program to the network.

30. An image forming apparatus according to claim 29, further comprising:
a storage configured to store the inspection program.

31. An image forming apparatus according to claim 29, wherein the inspection program includes a migration agent program, and
the image forming apparatus further comprises a second control configured to execute the inspection program using a device as an agent of the image forming apparatus.

32. An image forming apparatus according to claim 29, for use with a computer configured to communicate with the image forming apparatus over the network and configured to manage the image forming apparatus, wherein:
the image forming apparatus further comprises a second control configured to send internal information to the computer; and
the computer is configured to send an inspection program depending on a determination based on the internal information.

33. An image forming apparatus according to claim 32, wherein:
the internal information includes static information.

34. An image forming apparatus according to claim 33, wherein:
the static information includes at least one of an identification information of the image forming apparatus and a number of recording mediums discharged from the image forming apparatus.

35. An image forming apparatus according to claim 32, wherein:
the computer is further configured to make a diagnosis based on the inspection result.

36. An image forming apparatus according to claim 35, wherein:
the computer is further configured to send a procedure request depending on a result of the diagnosis.

37. An image forming apparatus according to claim 35, wherein:
the computer is further configured to send a diagnosis result depending on a result of the diagnosis.

38. An image forming apparatus according to claim 35, wherein:
the computer is further configured to order a component of the image forming apparatus depending on a result of the diagnosis.

39. A management method for managing an image forming apparatus that is configured to form an image on a recording medium, and output internal information, the management method comprising:
receiving the internal information; and
sending to the image forming apparatus an inspection program depending on a determination based on the internal information.

40. A management method according to claim 39, wherein:
the internal information includes static information.

41. A management method according to claim 40, wherein:
the static information includes at least one of an identification information of the image forming apparatus and a number of recording mediums discharged from the image forming apparatus.

42. A management method according to claim 39, wherein the image forming apparatus is further configured to execute the inspection program, and send an inspection result obtained by execution of the inspection program to a computer, the management method further comprising:
making a diagnosis based on the inspection result.

43. A management method according to claim 42, further comprising:
outputting a procedure request depending on a result of the diagnosis.

44. A management method according to claim 42, further comprising:
outputting a diagnosis result depending on a result of the diagnosis.

45. A management method according to claim 42, further comprising:
ordering a component of the image forming apparatus depending on a result of the diagnosis.

46. A management method according to claim 39, wherein:
the inspection program is configured to be storable in the image forming apparatus.

47. A management method according to claim 39, wherein:
the inspection program includes a migration agent program.

48. An inspection method comprising:
forming an image on a recording medium by an image forming apparatus;
executing an inspection program sent to the image forming apparatus from a network for inspecting the image forming apparatus; and
sending an inspection result obtained by execution of the inspection program in the image forming apparatus to the network.

49. An inspection method according to claim 48, further comprising:
storing the inspection program in the image forming apparatus.

50. An inspection method according to claim 48, wherein:
the inspection program includes a migration agent program; and
the inspection method further comprises executing the inspection program using a device as an agent.

51. An inspection method according to claim 48, further comprising:
sending internal information of the image forming apparatus to the network, wherein
the inspection program is sent depending on a determination based on the internal information.

52. An inspection method according to claim 51, wherein:
the internal information includes static information.

53. An inspection method according to claim 52, wherein:
the static information includes at least one of an identification information of the image forming apparatus and a number of recording mediums formed discharged from the image forming apparatus.

54. A management method comprising:
sending internal information from an image forming apparatus to a network;
receiving at a computer on the network the internal information from the network; and
sending an inspection program to the image forming apparatus depending on a determination based on the internal information, from the network.

55. A management method according claim 54, further comprising:
receiving at the image forming apparatus the inspection program from the network; and
executing the inspection program at the image forming apparatus.

56. A management method according to claim 55, further comprising:
outputting an inspection result obtained by execution of the inspection program, to the network.

57. A management method according to claim 56, further comprising:
receiving at the computer the inspection result from the network; and
making a diagnosis based on the inspection result.

58. A system comprising:
an apparatus; and
a computer configured to manage the apparatus, wherein:
said apparatus is configured to send internal information to said computer; and
said computer is configured to send an inspection program depending on a determination based on the internal information, to said apparatus.

59. A system according to claim 58, wherein:
said apparatus is configured to execute the inspection program.

60. A system according to claim 59, wherein:
said apparatus is configured to send an inspection result obtained by execution of the inspection program, to said computer.

61. A system according to claim 60, wherein:
said computer is configured to make a diagnosis based on the inspection result.

62. An image forming system comprising:
means for forming an image on a recording medium; and
means for managing said means for forming an image;
wherein:
said means for forming an image includes means for sending internal information to said means for managing; and
said means for managing includes means for sending an inspection program to said means for forming an image depending on a determination based on the internal information.

63. A computer for use with an image forming apparatus having means for forming an image on a recording medium, and means for sending internal information to the computer, comprising:
means for sending an inspection program to said means for forming an image depending on a determination based on the internal information.

64. An image forming apparatus for forming an image on a recording medium, comprising:
means for executing an inspection program sent from a network; and
means for sending an inspection result obtained by execution of the inspection program.
